(19) United States
(12) Patent Application Publication
(10) Pub. No.: US 2020/0227942 A1
(43) Pub. Date: Jul. 16, 2020

(54) WIRELESS CHARGER AND FURNITURE HAVING THE SAME

(71) Applicant: Chemtronics Co., Ltd., Sejong (KR)

(72) Inventors: Jae Min JUNG, Yongin-si (KR); Joon Hoo LEE, Yongin-si (KR)

(73) Assignee: Chemtronics Co., Ltd., Sejong (KR)

(21) Appl. No.: 16/732,595

(22) Filed: Jan. 2, 2020

(30) Foreign Application Priority Data
Jan. 16, 2019 (KR) 10-2019-0005519

(51) Int. Cl. H02J 50/10; H02J 7/02; H02J 7/00; A47B 21/06

(52) U.S. Cl. CPC H02J 50/10; H02J 7/02; A47B 2021/066; A47B 21/06; H02J 7/0047

(57) ABSTRACT

A wireless charger includes a main body provided with an inner space defined therein and including a supporter, a circuit part disposed on the supporter, and a coil part disposed on the circuit part and supplying a power to an external object to be charged. The main body includes a first supporting member protruding from one surface of the supporter of the main body and supporting the coil part such that the circuit part and the coil part are spaced apart from each other.

### CROSS-REFERENCE TO RELATED APPLICATION

This U.S. non-provisional patent application claims priority under 35 U.S.C. § 119 of Korean Patent Application No. 10-2019-0005519, filed on Jan. 16, 2019, the contents of which are hereby incorporated by reference in its entirety.

### BACKGROUND

### 1. Field of Disclosure

The present disclosure relates to a wireless charger. More particularly, the present disclosure relates to a wireless charger easily attachable to and detachable from a furniture.

### 2. Description of the Related Art

In general, a wireless charger includes a transmitter for supplying wireless power and a receiver for receiving the wireless power. When the transmitter and the receiver are arranged at a certain distance from one another, an induced magnetic field is formed between the transmitter and the receiver, and thus, the receiver receives the power transmitted from the transmitter.

The wireless power transmitter of the wireless charger is manufactured in a pad shape. To charge an electronic device, a charging operation is performed by placing the wireless power transmitter on a desk or table and then positioning the electronic device on the wireless power transmitter.

### SUMMARY

The present disclosure provides a wireless charger capable of easily accommodating a circuit part and a coil part and being easily attachable to and detachable from a mounting surface.

Embodiments of the inventive concept provide a wireless charger including a main body provided with an inner space defined therein and including a supporter, a circuit part disposed on the supporter, and a coil part disposed on the circuit part and supplying a power to an external object to be charged. The supporter includes a first supporting member protruding from one surface of the supporter and supporting the coil part such that the circuit part and the coil part are spaced apart from each other.

The supporter further includes a second supporting member protruding from the one surface of the supporter and supporting the circuit part such that the circuit part and the supporter are spaced apart from each other.

The main body has a cylindrical shape having a screw thread on an entire area of an outer circumferential surface thereof.

The wireless charger further includes a coupling part having an open shape through which the main body penetrates and including a screw thread on an inner circumferential surface thereof to be rotatably coupled to the outer circumferential surface of the main body and a guide member including an extension part extending in a circumferential direction from one end portion or the other end portion of the coupling part.

The extension part includes at least one coupling hole defined therein.

The wireless charger further includes a coupling member rotatably coupled to the coupling hole and inserted into a mounting surface to tightly fix the extension part to the mounting surface.

The supporter includes at least one through hole defined therethrough such that a heat generated by the circuit part and the coil part is discharged to an outside through the supporter.

The main body further includes a cover part that is disposed at one end of the main body and covers the circuit part and the coil part to protect the circuit part and the coil part from external impacts.

The main body further includes a display member disposed on the supporter or the coil part to emit a light to a mounting surface on which the main body is mounted and to display a location of the main body on an opposite surface to the mounting surface.

The circuit part further includes a switch exposed to an outside to control an operation of the wireless charger.

Embodiments of the inventive concept provide a furniture including a wireless charger and an external member at which the wireless charger is installed. The wireless charger includes a main body provided with an inner space defined therein and including a supporter, a circuit part disposed on the supporter, and a coil part disposed on the circuit part and supplying a power to an external object to be charged. The main body includes a first supporting member protruding from one surface of the supporter of the main body and supporting the coil part such that the circuit part and the coil part are spaced apart from each other.

According to the above, the wireless charger may easily accommodate the circuit part and the coil part and may be easily attached to and detached from the mounting surface.

### BRIEF DESCRIPTION OF THE DRAWINGS

The above and other advantages of the present disclosure will become readily apparent by reference to the following detailed description when considered in conjunction with the accompanying drawings wherein:

FIG. 1 is an exploded perspective view showing a wireless charger according to an exemplary embodiment of the present disclosure;

FIG. 2 is a cross-sectional view showing a wireless charger according to an exemplary embodiment of the present disclosure;

FIG. 3 is a top view showing a supporter included in a wireless charger according to an exemplary embodiment of the present disclosure;

FIG. 4 is a perspective view showing a main body according to an exemplary embodiment of the present disclosure;

FIG. 5 is a cross-sectional view showing a wireless charger buried in an external member according to an exemplary embodiment of the present disclosure;

FIGS. 6A and 6B are perspective views showing a main body and a guide member coupled to the main body according to an exemplary embodiment of the present disclosure;

FIG. 7 is a cross-sectional view showing a main body and a guide member according to an exemplary embodiment of the present disclosure;

FIG. 8 is a cross-sectional view showing a main body and a guide member, which are buried in a mounting surface, according to an exemplary embodiment of the present disclosure; and

FIG. 9 is an exploded perspective view showing a wireless charger according to an exemplary embodiment of the present disclosure.

### DETAILED DESCRIPTION

Hereinafter, exemplary embodiments of the present disclosure will be described in detail with reference to accompanying drawings. In the drawings, like reference numerals are used to denote like elements throughout the drawings even though they are shown on different drawings, in the following description of the present disclosure, a detailed description of known functions and configurations incorporated herein will be omitted when it may make the subject matter of the present disclosure rather unclear,

In addition, in describing components of the present disclosure, when an element is described as being “connected”, “coupled” or “contacted” to another component, the component may be directly connected to or contacted to the other component, however it should be understood that other components may be “connected”, “coupled”, or “contacted” between the components.

In general, a wireless charger includes a transmitter for supplying a wireless power and a receiver for receiving the wireless power. When the transmitter and the receiver are arranged at a certain distance from one another, an induced magnetic field is formed between the transmitter and the receiver, and thus, the receiver receives the power transmitted from the transmitter.

A wireless charger according to an exemplary embodiment of the present disclosure may use the above principle and may include a circuit board, a coil, and a main body to accommodate the circuit board and the coil, and the wireless charger may be buried in a lower portion of a table.

However, the wireless charger according to an exemplary embodiment of the present disclosure should not be limited to the above-mentioned application structure and manner, and the wireless charger may be used after being fixed on an upper portion of the table. In a case where the wireless charger is installed on a wall, the wireless charger may be used in a variety of ways, for example, being used with a charging station.

Hereinafter, in exemplary embodiments of the present disclosure, the size, thickness, and shape of each component are exaggerated for the convenience of explanation, and the wireless charger may have a size and a shape, which are different from the above size and shape. In addition, spatially relative terms, such as “upper”, “lower”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

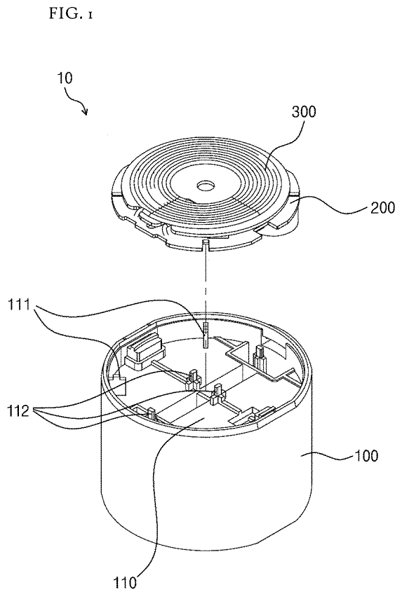

FIG. 1 is an exploded perspective view showing a wireless charger 10 according to an exemplary embodiment of the present disclosure.

FIG. 2 is a cross-sectional view showing the wireless charger 10 according to an exemplary embodiment of the present disclosure.

Referring to FIGS. 1 and 2, the wireless charger 10 according to the exemplary embodiment of the present disclosure includes a main body 100 that includes an inner space and a supporter 110, a circuit part 200 disposed on the supporter 110, and a coil part 300 disposed on the circuit part 200 to supply a power to an external object to be charged.

The main body 100 accommodates the circuit part 200 and the coil part 300, and the main body 100 is inserted into or attached to a mounting surface. Thus, the circuit part 200 and the coil part 300 are held in a position adjacent to the mounting surface by the main body 100 so as not to be detached to the outside of the mounting surface.

The main body 100 may have a cylindrical shape or a polygonal column shape having a supporting surface supporting the circuit part 200 and the coil part 300 and may have an empty space therein.

In addition, the main body 100 may have a shape whose upper portion is opened such that the power transmitted from the coil part 300 to the external object to be charged is not shielded or a shape whose lower portion is opened such that heat generated by the circuit part 200 is easily discharged to the outside.

Accordingly, there are no obstacles between the external object to be charged and the coil part 300, and thus, an electromagnetic force is prevented from being shielded, and a charging efficiency increases.

The main body 100 should not be limited to the above-mentioned shapes and may have a variety of shapes as long as the shapes are appropriate to efficiently transmit the power and discharge the heat.

The main body 100 may be manufactured of a material that is light and thermally stable. Accordingly, although the main body 100 is exposed to the heat generated by the circuit part 200 or the coil part 300, the main body 100 may not be deformed. For example, the main body 100 may include one selected from polyethylene, polypropylene, polyvinyl chloride, polystyrene, acrylonitrile-butadiene-styrene resin, methacrylic resin, polyamide, polycarbonate, polyacetyl, polyethylene terephthalate, modified polyphenylene oxide, polybutylen terephthalate, polyurethane, phenolic resin, urea resin, melamine resin, and a combination thereof.

The supporter 110 may be disposed in the main body 100 to support the circuit part 200 and the coil part 300 and may have a flat plate shape.

The supporter 110 may have a shape corresponding to a cross-sectional shape of the main body 100 since the supporter 110 is disposed in the main body 100. However, the shape of the supporter 110 should not be limited thereto or thereby and may have a variety of shapes as long as the supporter 110 supports the circuit part 200 and the coil part 300.

The supporter 110 may be provided integrally with the main body 100 to be disposed in the main body 100 or may be provided to be detachable from the main body 100. When the main body 100 is provided to be detachable from the main body 100, the main body 100 may further include a coupling part disposed in an inner surface therein to be coupled to the supporter 110. Further, when the main body 100 includes a plurality of coupling parts arranged along the inner surface thereof, a position at which the supporter 110 is disposed may be changed in the main body 100 as needed.

The supporter 110 includes a first supporting member 111 protruding from one surface of the supporter 110 and supporting the coil part 300 to allow the circuit part 200 and the coil part 300 to be spaced apart from each other.

Therefore, the circuit part 200 and the coil part 300 have a gap therebetween without being closely attached to each other, and thus, the heat generated by a coil and transmitted directly to the circuit part 200 may be reduced, and circuit damage and overheating problems may be prevented.

In addition, since a surface area of the coil, which is in contact with the air, increases, a sufficient space is provided to transfer the heat generated by the coil into the air, thereby increasing the heat discharge efficiency.

The supporter 110 further includes a second supporting member 112 protruding from one surface of the supporter 110 and supporting the circuit part 200 to allow the circuit part 200 and the supporter 110 to be spaced apart from each other.

Thus, the circuit part 200 and the supporter 110 have a gap therebetween without being closely attached to each other, and thus, an overload problem caused when the supporter 110 blocks the transfer of the heat from the circuit part 200 to the air may be solved.

As the first supporting member 111 and the second supporting member 112 have a stepped portion with a step difference at an upper end portion thereof, an outer circumference surface of the circuit part 200 or the coil part 300 is supported by the first and second supporting members 111 and 112 so as not to be detached.

In addition, according to the exemplary embodiment of the present disclosure, the first supporting member 111 has the stepped portion defined by two or more different heights at its upper end portion to accommodate the coil part 300 having various diameters. Accordingly, it is possible to accommodate coils having different diameters, such as about 10 W and about 15 W.

In the exemplary embodiment of the present disclosure, the first supporting member 111 may be formed to be higher than the second supporting member 112. For example, the first supporting member 111 may have a height greater than a sum of a height of the second supporting member 112 and a thickness of the circuit part 200 disposed on and supported by the second supporting member 112.

When the height of the first supporting member 111 is greater than the sum of the height of the second supporting member 112 and the thickness of the circuit part 200, an upper surface of the circuit part 200 and a lower surface of the coil part 300 may be spaced apart from each other.

As the upper surface of the circuit part 200 and the lower surface of the coil part 300 are spaced apart from each other, the heat generated by the circuit part 200 or the coil part 300 may be discharged to the outside through a space between the circuit part 200 and the coil part 300. Therefore, it is effective to prevent defects and damages of the device due to the heat problem or a power cut off due to the overload of the device.

In the exemplary embodiment of the present disclosure, the circuit part 200 may be provided in the form of substrate and may include a circuit or an antenna to receive the power.

In the exemplary embodiment of the present disclosure, the coil part 300 may include the coil that supplies the power from the circuit part 200 to the external object to be charged and a coil supporter that supports a lower portion of the coil.

The coil of the coil part 300 may be wound in a clockwise or counterclockwise direction and may be provided in a circular, elliptical, polygonal, or square shape, and the coil of the coil part 300 may be provided as a 10 W or 15 W wireless charging coil.

In addition, the coil according to the exemplary embodiment of the present disclosure may be provided including a coil for an electronic payment system, a coil for a short distance data communication system, and the like to perform various functions depending on the purpose of use, such as an electronic payment and a short-range data communication.

According to an exemplary embodiment of the present disclosure, the circuit part 200 and the coil part 300 are supported by the supporter 110, and the circuit part 200 and the coil part 300 are spaced apart from each other by the first supporting member 111 protruding from the one surface of the supporter 110. Thus, the circuit part 200 or the coil part 300 may be prevented from being damaged due to the heat generated by the wireless charger 10. Further, as the main body 100 does not cover the coil part 300, the power transfer between the external object to be charged and the coil part 300 may be more effectively performed. Accordingly, when the wireless charger 10 according to the exemplary embodiment of the present disclosure is used, the charging efficiency is very high.

In the above descriptions, a basic form of the wireless charger according to the exemplary embodiment of the present disclosure has been described. However, the wireless charger according to the exemplary embodiment of the present disclosure may further include additional components described below to remove the heat generated by the circuit part and the coil part and to increase an operation efficiency.

In an exemplary embodiment of the present disclosure, the supporter 110 may further include a through hole 113 and a conduit hole 114, and the circuit part may further include a switch 210.

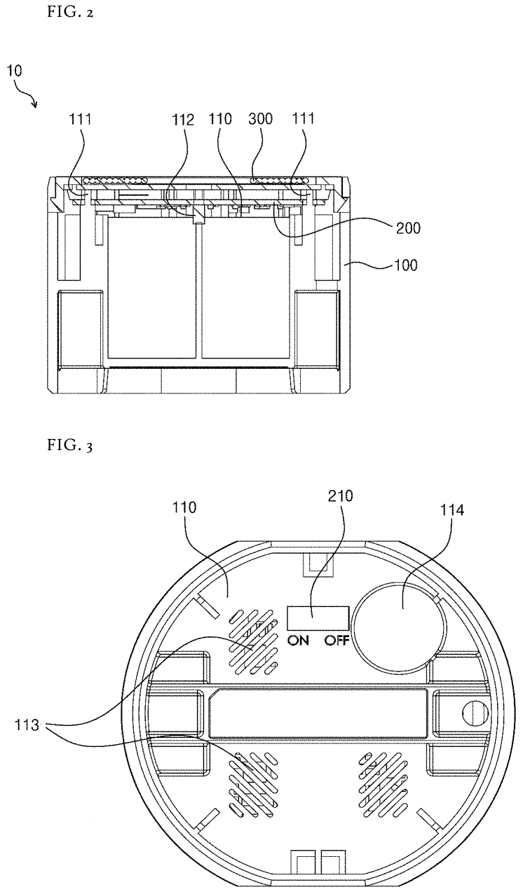

FIG. 3 is a top view showing the supporter 110 included in the wireless charger according to an exemplary embodiment of the present disclosure.

Referring to FIG. 3, the supporter 110 may include at least one through hole 113 such that the heat generated by the circuit part and the coil part is discharged to the outside through the supporter 110. Accordingly, it is effective in preventing the heat problems, such as circuit damage, due to the heat generated in the circuit part and the coil part.

A shape of the through hole 113 should not be limited. For example, the through hole 113 may be provided in a plural number, and the through holes 113 may have different lengths from each other as shown in FIG. 3. In addition, the through holes 113 may be arranged in different areas of the supporter 110 to be spaced apart from each other, so that the heat generated by the circuit part and the coil part may be evenly discharged.

The conduit hole 114 may be defined in the supporter 110 and may have a predetermined diameter such that wirings and cables connected to the circuit part or the coil part are withdrawn to the outside through the supporter 110. The wirings and the cables may be connected to an external power terminal, such as a plug, to receive the power. Since a separate path for withdrawing the wirings or cables is not required, a structure may be simplified, and a manufacturing process may be facilitated. In addition, it is possible to run the wirings safely and to prevent damage of the sheath of the wires.

The heat generated by the circuit part and the coil part may be discharged through the conduit hole 114. Therefore, the through hole 113 may not be provided in an area in which the conduit hole 114 is provided. Further, the conduit hole 114 may be provided to be spaced apart from the through hole 113.

In addition, in the exemplary embodiment of the present disclosure, the circuit part may further include the switch 210 exposed to the outside to control the operation of the wireless charger. In more detail, the switch 210 may control an operation of the circuit part and a display member electrically connected to the circuit part.

In an exemplary embodiment, the switch 210 may control on/off of the power supplied to the circuit part from an external power supply terminal to the circuit part. In this case, the switch 210 may be provided to penetrate through the supporter 110, and thus, it is able to operate the switch 210 on a side opposite to a side where the circuit part is provided when the circuit part is disposed on the supporter 110. Accordingly, a user may conveniently operate the switch 210 without separating the circuit part from the supporter 110 to control the supply of power provided to the circuit part.

In another exemplary embodiment, the switch 210 may control on/off of a light emission of the display member electrically connected to the circuit part. The display member emits a light when the power is provided thereto from the external power supply terminal, and thus, the user may easily determine from the outside whether the power is being supplied. That is, the switch 210 may control whether to supply the power to the circuit part, and substantially simultaneously, may control the display device to inform the user of the power supply state of the wireless charger.

In another exemplary embodiment, the switch 210 may control a light emission pattern in addition to a light emission of the display device. Accordingly, the switch 210 may provide a user with an alarm function according to a specific situation by controlling the display device to output different light emitting patterns in the specific situation. For example, when the external object to be charged is wirelessly connected to or disconnected from the wireless charger or when the external object to be charged is completely charged, the display device may be controlled to output different light emission patterns from each other depending on the situations.

In another exemplary embodiment, the switch 210 may be provided to be electrically connected to a buzzer that outputs different buzzing sounds in the above-described specific situations. When the switch 210 applies a signal corresponding to the state of the wireless charger to the buzzer, the buzzer receives the signal and outputs the buzzing sound corresponding to the received signal, and thus, the state of the wireless charger may be easily figured out.

In addition, the switch 210 may control the buzzer and may control the light emission pattern of the display device substantially simultaneously, so that the user may easily figure out the operation state of the wireless charger. The wireless charger according to an exemplary embodiment of the present disclosure may include a screw thread on its outer circumference surface.

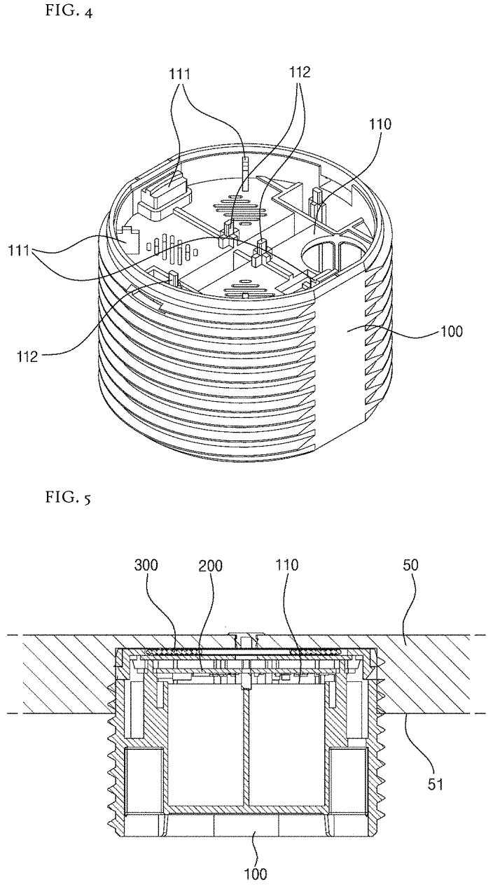

FIG. 4 is a perspective view showing a main body 100 according to an exemplary embodiment of the present disclosure, and FIG. 5 is a cross-sectional view showing a wireless charger buried in an external member 50 according to an exemplary embodiment of the present disclosure.

Referring to FIGS. 4 and 5, the main body 100 according to the exemplary embodiment of the present disclosure may be provided in a cylindrical shape having a screw thread on the entire outer circumferential surface thereof and may be buried in the mounting surface 51.

Accordingly, the main body 100 may be more easily buried in the external member, and the screw threads may support the buried state of the main body 100, thereby preventing the main body 100 from being separated from the external member 50 to the outside.

In the above-described embodiment, a lower surface of the desk or the table has been described as a representative example of the mounting surface 51, however, the mounting surface 51 should not be limited thereto or thereby, and various surfaces, such as an upper surface of the table or a wall surface, may be used as the mounting surface 51.

The wireless charger according to an exemplary embodiment of the present disclosure may further include a guide member.

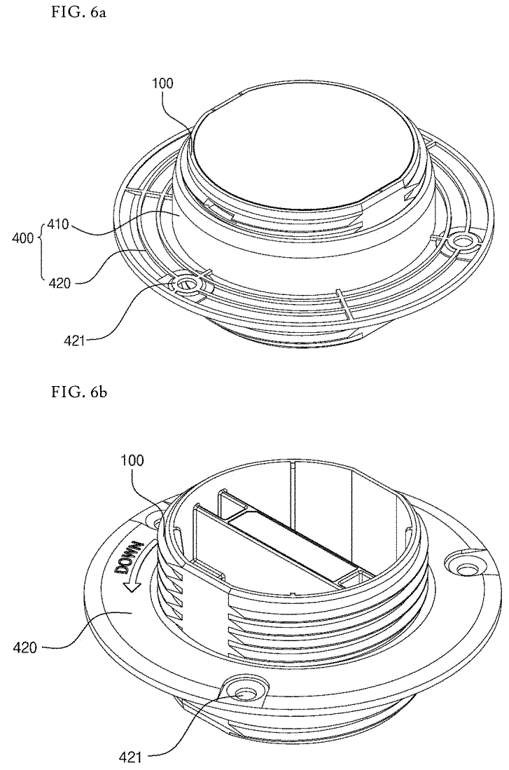

FIGS. 6A and 6B are perspective views showing a main body 100 and a guide member 400 coupled to the main body 100 according to an exemplary embodiment of the present disclosure.

Referring to FIGS. 6A and 6B, the wireless charger according to the exemplary embodiment of the present disclosure may further include the guide member 400. The guide member 400 may include a coupling part 410 having an open shape through which the main body 100 may penetrate and having a screw thread formed on its inner circumferential surface to be rotatably coupled with an outer circumferential surface of the main body 100 and an extension part 420 extending in a circumferential direction from one end or the other end of the coupling part 410.

The guide member 400 may be provided to surround an outer portion of the main body 100 and may be provided to be rotatably coupled with the main body 100, and thus, the guide member 400 may prevent the main body 100 from shaking and may support the main body 100 to be stably fixed to the mounting surface.

For example, in a case where it is difficult to bury and fix the main body 100 alone due to a poor quality of the mounting surface of the external member 50, the guide member 400 may be first buried in and fixed to the mounting surface and may guide the main body 100 such that the main body 100 is stably buried in the external member 50 through the rotational coupling.

In figures, the coupling part 410 is shown to have a height smaller than a height of the main body 100, however, it should not be limited thereto or thereby. That is, the coupling part 410 may have substantially the same height as or a height greater than the height of the main body 100.

In addition, the extension part 420 is shown to have a circular shape to surround an outer circumferential surface of the guide member 400, however, the shape of the extension part 420 should not be limited to the circular shape. The extension part 420 may have a variety of shapes.

For example, the extension part 420 may have a wing shape protruding outward from around the outer circumferential surface of the guide member 400, and a plurality of wing-shaped extension parts 420 may be arranged to be spaced apart from each other.

In an exemplary embodiment of the present disclosure, the extension part 420 may be provided with at least one coupling hole 421, and a coupling member described below may be inserted into the coupling hole 421, thereby fixing the extension part 420 of the guide member 400 to the mounting surface.

In an exemplary embodiment of the present disclosure, a screw thread may be provided on an inner circumferential surface of the coupling hole 421, and the shape of the coupling hole 421 should not be particularly limited.

The wireless charger according to the exemplary embodiment of the present disclosure may further include a coupling member rotatably coupled with the coupling hole.

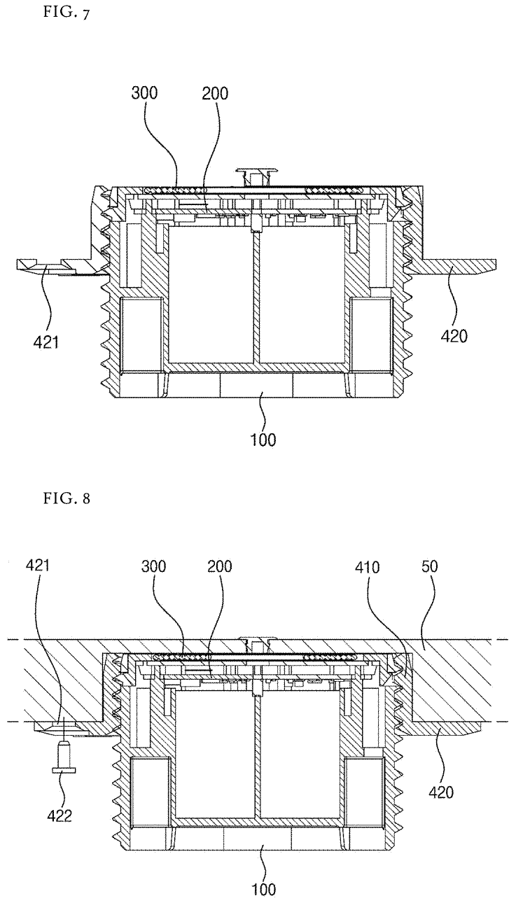

FIG. 7 is a cross-sectional view showing a main body and a guide member according to an exemplary embodiment of the present disclosure, and FIG. 8 is a cross-sectional view showing a main body and a guide member, which are buried in a mounting surface, according to an exemplary embodiment of the present disclosure.

Referring to FIGS. 7 and 8, the coupling member 422 according to the exemplary embodiment may be rotatably coupled to the coupling hole 421 and may be buried in the mounting surface 51 to attach and fix the extension part 420 to the mounting surface 51.

Accordingly, since the coupling part 410 of the guide member is buried in the external member 50 and the extension part 420 is tightly fixed between the coupling member 422 and the mounting surface 51, the main body 100 is supported in the coupling part 410 and prevented from being separated from the mounting surface 51.

In FIGS. 7 and 8, the coupling member 422 has a screw thread on its outer surface, however, it should not be limited thereto or thereby. That is, any coupling member 422, which has a head portion with a diameter greater than the coupling hole 421 to enable the extension part 420 to be tightly fixed onto the mounting surface 51, is applicable.

Hereinafter, effects obtained when the main body of the wireless charger and the coupling part of the guide member according to an embodiment of the present disclosure are provided as a cylindrical shape will be described.

Referring to FIGS. 7 and 8 again, in the exemplary embodiment of the present disclosure, the main body 100 may be provided in the cylindrical shape having the same upper and lower outer circumferential diameters. In addition, in the exemplary embodiment of the present disclosure, the coupling part 410 of the guide member may be provided in the cylindrical shape having the same upper and lower inner circumferential diameters.

Accordingly, when the main body 100 is attached to or detached from the guide member, the main body 100 may be easily attached or detached since it is possible to attach or detach the main body 100 to and from the guide member only by rotating the main body 100 without uncoupling the coupling of the coupling member 422 or removing the guide member.

In addition, even when a thickness of the mount target in which the wireless charger is buried is thicker or thinner than the height of the main body 100, the main body 100 may be easily mounted on the mounting surface 51 as long as the extension part 420 of the guide member makes contact with the mounting surface 51 and is fixed by the coupling member 422.

Further, since the main body 100 is provided to completely penetrate through the upper and lower portions of the coupling part 410, the main body 100 may be coupled with the coupling part 410 in all directions when the main body 100 is inserted into the guide member.

That is, since an upper end or a lower end of the main body 100 may be coupled to an upper end or a lower end of the coupling part 410, the wireless charger may be coupled with external members having various mounting surfaces in various coupling structures.

For example, in a case where a lower surface of the external member 50 is used as the mounting surface 51, the guide member having the shape in which the extension part 420 is disposed at a lower end portion of the coupling part 410 may be buried in a buried hole defined in the external member 50, and an upper end portion of the main body 100 may be inserted and coupled through the lower end of the coupling part 410. In addition, the guide member having the shape in which the extension part 420 is disposed at an upper end portion of the coupling part 410 may be tightly fixed to the mounting surface 51 of the external member 50, and the upper end portion of the main body 100 may be inserted and coupled through the lower end of the coupling part 410.

On the contrary, in a case where an upper surface of the external member 50 is used as the mounting surface 51, the guide member having the shape in which the extension part 420 is disposed at the upper end portion of the coupling part 410 may be buried in the buried hole defined in the external member 50, and a lower end portion of the main body 100 may be inserted and coupled through the upper end of the coupling part 410. In addition, the guide member having the shape in which the extension part 420 is disposed at the lower end portion of the coupling part 410 may be tightly fixed to the mounting surface 51 of the external member 50, and the lower end portion of the main body 100 may be inserted and coupled through the upper end of the coupling part 410.

As described above, the wireless charger may be mounted in a variety of mounting methods depending on the presence of the buried hole of the external member 50, the arrangement direction of the mounting surface 51, and the purpose of use, etc., while utilizing the unique effects of the wireless charger according to an exemplary embodiment of the present disclosure.

In the following descriptions, exemplary embodiments according to the presence or absence of the buried hole in the mounting surface and the direction in which the guide member is coupled with respect to the mounting surface will be described.

In an exemplary embodiment of the present disclosure, as the coupling part 410 of the guide member is buried in the external member 50 and the coupling member 422 is inserted into and coupled to the coupling hole 421 of the extension part 420, one surface of the extension part 420 may make contact with and tightly fixed to the mounting surface 51. In this case, when the buried hole is defined in the mounting surface 51, the main body 100 may be rotatably inserted into the coupling part 410 to be buried in the mounting surface 51.

In addition, in an exemplary embodiment of the present disclosure, as the coupling part 410 of the guide member is located outside the mounting surface 51 and the coupling member 422 is inserted into and coupled to the coupling hole 421 of the extension part 420, the other surface of the extension part 420 may make contact with and tightly fixed to the mounting surface 51.

In the case where the guide member is mounted on the mounting surface 51 in the above-mentioned coupling direction, the main body 100 may be rotatably coupled with the coupling part 410 of the guide member to be mounted on the mounting surface 51 regardless of the presence or absence of the buried hole.

That is, the main body 100 may be fixed by using the coupling structure of the extension part 420, the coupling hole 421, and the coupling member 422 of the guide member as a fixing member with respect to the mounting surface 51 without burying the main body 100 or the coupling part 410 in the external member 50. Accordingly, the main body 100 may be fixed to various mounting surfaces 51 in which no buried hole is defined.

Hereinafter, exemplary embodiments in which the wireless charge is mounted on a horizontal or vertical mounting surface will be described.

When the wireless charger according to an embodiment of the present disclosure is buried in a lower portion of an upper plate member, such as a table, a screw thread may be formed on each of an inner circumferential surface of the coupling part 410 and an outer circumferential surface of the main body 100, and thus, the coupling part 410 and the main body 100 may be rotatably coupled with each other.

When the wireless charger according to an embodiment of the present disclosure is buried in an upper portion of an upper plate member, such as a table, the wireless charger may be buried in the upper portion of the table, and a structure that covers an upper surface of the wireless charger, such as a hinge or a sliding door, may be provided above the wireless charger, thereby maintaining the usable area and the aesthetic appearance of the table.

In addition, when the wireless charger according to an embodiment of the present disclosure is buried in a vertical member such as a wall, the wireless charger may be provided with a supporter that supports a lower portion of an external object to be charged.

As described above, the external member may be provided in various ways, and a furniture including the wireless charger according to the exemplary embodiment of the present disclosure may include both the external member and the wireless charger.

The wireless charger according to an exemplary embodiment of the present disclosure may further include the following additional components.

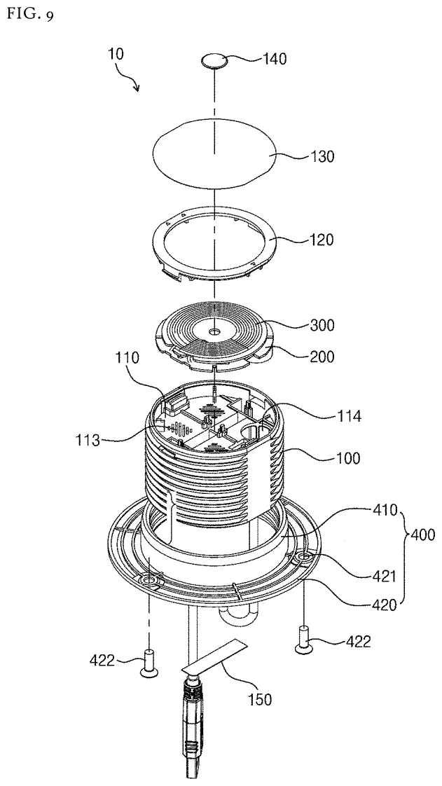

FIG. 9 is an exploded perspective view showing a wireless charger 10 according to an exemplary embodiment of the present disclosure.

Referring to FIG. 9, in the exemplary embodiment of the present disclosure, a main body 100 may further include a holder part 120 that covers an upper portion of a coil part 300 such that a circuit part 200 and the coil part 300 are not separated from the main body 100.

In the exemplary embodiment of the present disclosure, the holder part 120 may be provided on a supporter 110 or may be provided in the form of a cap to be fitted and coupled to an upper end portion of the main body 100.

The holder part 120 may have a ring shape through which a hole is defined at a center thereof and may prevent a path through which a power is provided to an external object to be charged from the coil part 300 from being shield, thereby increasing the charging efficiency.

In addition, in the exemplary embodiment of the present disclosure, the main body 100 may further include a cover part 130 disposed at one end of the main body 100 to cover the cover part 200 and the coil part 300, and thus, the cover part 200 and the coil part 300 may be protected.

When the main body 100 has a shape in which an upper portion of the main body 100 is opened, the cover part 130 may be attached to the upper end portion of the main body 100 or an upper or lower portion of the holder 120 and may cover the upper portion of the coil part 300, and thus, the coil part 300 and the circuit part 200 may be prevented from being damaged due to external impacts.

The cover part 130 may be provided in the form of a film and may be formed of a transparent or semi-transparent material that does not shield the power.

In addition, in the exemplary embodiment of the present disclosure, the main body 100 may further include a display member 140 provided on the supporter 110 or the coil part 300 to emit a light to a mounting surface on which the main body 100 is mounted. The display member 140 may display a location of the main body 100 at an opposite surface to the mounting surface.

The display member 140 may be a lighting device, such as an LED, and it is able to determine a connection state between the wireless charger 10 and an external power terminal depending on whether the display member 140 emits the light.

For example, in the case where the wireless charger 10 of the present disclosure is buried in a lower portion of a table, a hole may be defined through from the mounting surface to the opposite surface or the table may be formed of the transparent material to allow the light emission state of the display member 140 to be checked at the opposite surface to the mounting surface, and thus, it is able to check whether the light is emitted from the outside.

Accordingly, since a separate display device is not required on the upper portion of the table, the usable area of the table is not reduced, and the aesthetic appearance of the table is maintained.

In the exemplary embodiment of the present disclosure, the main body 100 may further include an inner space that is empty and defined in the lower portion of the supporter 110, and the inner space may be used as a space through which the heat generated by the circuit part 200 or the coil part 300 disposed on the supporter 110 is discharged. In this case, since the lower surface of the main body 100 has an open shape, the heat generated by the circuit part 200 may be easily discharged to the outside.

In addition, in the exemplary embodiment of the present disclosure, an air blower in a fan shape may be disposed in the inner space, and thus, it has the effect of accelerating the discharge of heat generated by the circuit part 200 or the coil part 300 to the outside through the supporter 110.

In addition, in the exemplary embodiment of the present disclosure, the inner space may be used as a space in which a charging device, such as a battery, is accommodated, and a wiring connected between the charging device and the circuit part 200 and between the charging device and the coil part 300 may be accommodated in the inner space.

Therefore, it is able to prevent the wire, which is withdrawn out through the lower portion of the main body 100 and connected to the power terminal, from being exposed to the outside unnecessarily, and thus, damages on the sheath of the wire due to the external impacts and the current leakage may be prevented and the aesthetic appearance may be maintained.

In addition, in the exemplary embodiment of the present disclosure, a handle part 150 may be disposed on the lower portion of the supporter 110 of the main body 100 to facilitate a rotational movement when the main body 100 is buried in the mounting surface, such as a plate member.

When using the above-described handle part 150, the user may easily rotate the main body 100 by holding the handle part 150 with hands or using a tool, and thus, the main body 100 may be easily buried in the external member 50 having a deep buried hole.

The shape of the handle part 150 should not be limited to that shown in FIG. 9, and the handle part 150 may have any structure as long as it is easy to rotate by hands or tools from the outside.

In the above, even though it is described that all the components configuring the exemplary embodiment of the present invention as described above are coupled as one or are operated by being coupled with each other, the present invention is not necessarily limited to the exemplary embodiments. That is, all the components may be operated by being optionally coupled with each other within the scope of the present invention.

It is also to be understood that the terms such as “comprises”, “comprising”, or “having”, as used herein, mean that a component can be implanted unless specifically stated to the contrary. But should be construed as including other elements. Unless otherwise defined, all terms (including technical and scientific terms) used herein have the same meaning as commonly understood by one of ordinary skill in the, art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the present disclosure has been described with reference to exemplary embodiments, it will be apparent to those skilled in the art that various changes and modifications may be made without departing from the spirit and scope of the present disclosure. Therefore, exemplary embodiments of the present disclosure are not limiting, but illustrative, and the spirit and scope of the present disclosure is not limited thereto. The spirit and scope and the present disclosure should be interpreted by the following claims, it should be interpreted that all technical ideas which are equivalent to the present disclosure are included in the spirit and scope of the present disclosure.

What is claimed is:

1. A wireless charger comprising:
a main body provided with an inner space defined therein and comprising a supporter;
a circuit part disposed on the supporter; and
a coil part disposed on the circuit part and supplying a power to an external object to be charged, wherein the supporter comprises a first supporting member protruding from one surface of the supporter and supporting the coil part such that the circuit part and the coil part are spaced apart from each other.

2. The wireless charger of claim 1, wherein the supporter further comprises a second supporting member protruding from the one surface of the supporter and supporting the circuit part such that the circuit part and the supporter are spaced apart from each other.

3. The wireless charger of claim 1, wherein the main body has a cylindrical shape having a screw thread on an entire area of an outer circumferential surface thereof.

4. The wireless charger of claim 3, further comprising:
a coupling part having an open shape through which the main body penetrates and comprising a screw thread on an inner circumferential surface thereof to be rotatably coupled to the outer circumferential surface of the main body; and
a guide member comprising an extension part extending in a circumferential direction from one end portion or the other end portion of the coupling part.

5. The wireless charger of claim 4, wherein the extension part comprises at least one coupling hole defined therein.

6. The wireless charger of claim 5, further comprising a coupling member rotatably coupled to the coupling hole and inserted into a mounting surface to tightly fix the extension part to the mounting surface.

7. The wireless charger of claim 1, wherein the supporter comprises at least one through hole defined therethrough such that a heat generated by the circuit part and the coil part is discharged to an outside through the supporter.

8. The wireless charger of claim 1, wherein the main body further comprises a cover part that is disposed at one end of the main body and covers the circuit part and the coil part to protect the circuit part and the coil part from external impacts.

9. The wireless charger of claim 1, wherein the main body further comprises a display member disposed on the supporter or the coil part to emit a light to a mounting surface on which the main body is mounted and to display a location of the main body on an opposite surface to the mounting surface.

10. The wireless charger of claim 1, wherein the circuit part further comprises a switch exposed to an outside to control an operation of the wireless charger.

11. A furniture comprising:
a wireless charger; and
an external member at which the wireless charger is installed, the wireless charger comprising:
a main body provided with an inner space defined therein and comprising a supporter;
a circuit part disposed on the supporter; and
a coil part disposed on the circuit part and supplying a power to an external object to be charged, wherein the main body comprises a first supporting member protruding from one surface of the supporter of the main body and supporting the coil part such that the circuit part and the coil part are spaced apart from each other.
